(19) United States
(12) Patent Application Publication
(10) Pub. No.: US 2025/0114988 A1
(43) Pub. Date: Apr. 10, 2025

(54) INJECTION MOLDING MACHINE

(71) Applicant: SUMITOMO HEAVY INDUSTRIES, LTD., Tokyo (JP)

(72) Inventor: Shigeru TAKEUCHI, Chiba (JP)

(21) Appl. No.: 18/904,426

(22) Filed: Oct. 2, 2024

(30) Foreign Application Priority Data
Oct. 6, 2023 (JP) 2023-174293

(51) Int. Cl. B29C 45/02; B29C 45/76

(52) U.S. Cl. CPC B29C 45/02; B29C 45/76; B29C 2945/76598; B29C 2945/76682; B29C 2945/76859

(57) ABSTRACT

An injection molding machine includes a first cylinder to which a molding material is supplied; a first injection member provided in the first cylinder, the first injection member being configured to advance and retract; a second cylinder to which the molding material extruded from the first cylinder is supplied; a second injection member provided in the second cylinder, the second injection member being configured to advance and retract; and circuitry configured to control operations of the first injection member and the second injection member, wherein the circuitry controls a measuring step for supplying the molding material to the second cylinder by advancing the first injection member, and wherein the circuitry retracts the second injection member in accordance with the advancing of the first injection member in the measuring step.

### CROSS-REFERENCE TO RELATED APPLICATIONS

This application is based upon and claims priority to Japanese Patent Application No. 2023-174293 filed on Oct. 6, 2023, the entire contents of which are incorporated herein by reference.

### BACKGROUND

### 1. Technical Field

The present disclosure relates to an injection molding machine.

### 2. Description of Related Art

A conventional molding machine is known to utilize two cylinders to inject a molding material into a mold device. For example, Patent Document 1 discloses an injection molding machine including a first cylinder (a reservoir cylinder) to which a molten resin as a molding material is supplied and a second cylinder (an injection cylinder). In this injection molding machine, a first injection member (first plunger) of the first cylinder is advanced to discharge a molten resin from a distal end of the first cylinder, and the molten resin is accumulated in a front portion of an internal space of the second cylinder. Then, in the injection molding machine, a second injection member (second plunger) of the second cylinder is advanced to inject the molten resin accumulated in a front portion of the second cylinder into the mold device.

### SUMMARY

According to an aspect of the present disclosure, an injection molding machine is provided. The injection molding machine includes:
a first cylinder to which a molding material is supplied;
a first injection member provided in the first cylinder, the first injection member being configured to advance and retract;
a second cylinder to which the molding material extruded from the first cylinder is supplied;
a second injection member provided in the second cylinder, the second injection member being configured to advance and retract; and
circuitry configured to control operations of the first injection member and the second injection member,
wherein the circuitry controls a measuring step for supplying the molding material to the second cylinder by advancing the first injection member, and
wherein the circuitry retracts the second injection member in accordance with the advancing of the first injection member in the measuring step.

### BRIEF DESCRIPTION OF THE DRAWINGS

FIG. 1 is a side view illustrating an overall configuration of an injection molding machine system according to an embodiment.

FIG. 2 is a cross-sectional view schematically illustrating an injection device of an injection molding machine according to the embodiment.

FIG. 3 is a flowchart illustrating an operation of the injection device in the injection molding machine.

FIG. 4A is a sectional view illustrating an operation of the injection device in a measuring step.

FIG. 4B is a sectional view illustrating an operation of the injection device in an injection step.

FIG. 5 is a sectional view illustrating an operation of discharging a molten resin in the injection device.

FIG. 6A is a timing chart illustrating an operation of each plunger in a measuring step of the injection device according to the embodiment.

FIG. 6B is a timing chart illustrating an operation of each plunger in a measuring step of an injection device according to a reference example.

FIG. 7 is a sectional view schematically illustrating an injection device of an injection molding machine according to another embodiment.

### DETAILED DESCRIPTION

In the injection molding machine having the two cylinders as described above, when the molding material is supplied from the first cylinder to the second cylinder, the second injection member retracts under the pressure of the molding material flowing into the second cylinder. In this case, the first injection member requires a force for retracting the second injection member in addition to a force for extruding the molten resin from the first cylinder. This increases a pressure applied to the first injection member. The injection molding machine has thus the disadvantage that the first injection member or the first cylinder is easily damaged (durability is reduced) due to the increased pressure of the first injection member.

The present disclosure provides an injection molding machine capable of reducing the pressure of a first injection member at the time of extruding a molding material.

According to the aspect of the present disclosure, the pressure of the first injection member at the time of extruding the molding material can be reduced. Hereinafter, embodiments for implementing the present disclosure will be described with reference to the accompanying drawings. In the drawings, the same components are denoted by the same reference numerals, and a duplicated description thereof may be omitted.

### <Injection Molding Machine System S>

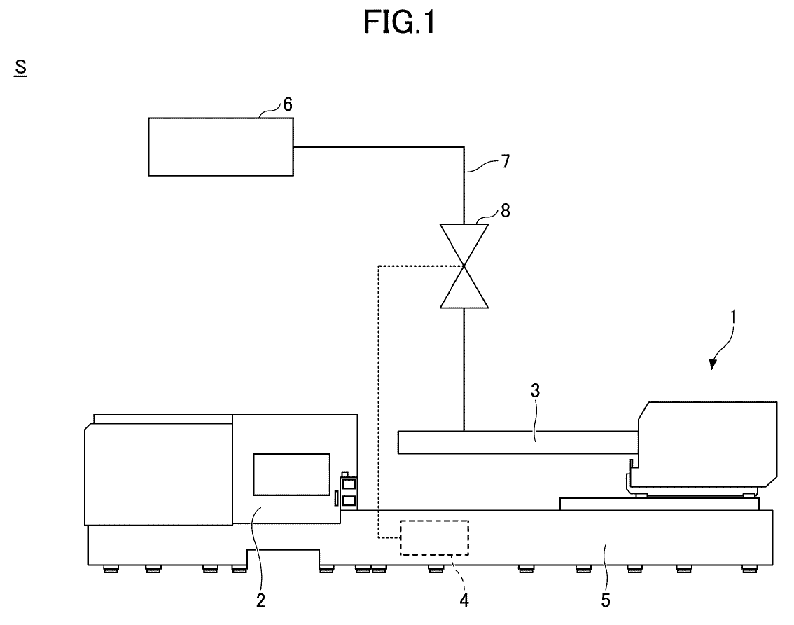

FIG. 1 is a side view illustrating an overall configuration of an injection molding machine system S according to an embodiment. As illustrated in FIG. 1, the injection molding machine system S according to the embodiment includes an injection molding machine 1, a molten resin supply device 6, a molten resin supply path 7, and a control valve 8.

The injection molding machine 1 includes a mold clamping device 2 that opens and closes a mold device (not illustrated), and an injection device 3 that injects a molding material into a cavity space of the mold device. The injection molding machine 1 also includes an ejector device (not illustrated) that ejects a molded product molded by the mold device, a moving device (not illustrated) that advances and retracts the injection device 3 with respect to the mold device, a frame 5 that supports each component of the injection molding machine 1, and the like. The injection molding machine 1 further includes a controller 4 that controls each component of the injection molding machine 1.

The mold clamping device 2 sequentially performs a mold closing step of causing the movable mold to touch the fixed mold, a pressurizing step of increasing the mold clamping force, a mold clamping step of maintaining the mold clamping force, a depressurizing step of reducing the mold clamping force, a mold opening step of separating the movable mold from the fixed mold, and the like based on a control instruction of the controller 4.

The injection device 3 performs a measuring step, a filling step, a holding pressure step, and the like based on a control instruction of the controller 4. Hereinafter, the filling step and the holding pressure step are also collectively referred to as an injection step. The operation of the injection device 3 will be described in detail later.

The ejector device performs an ejection step of advancing an ejector rod (not illustrated) from a standby position to an ejection position to eject a molded product and then retracting the ejector rod to the original standby position, based on a control instruction of the controller 4.

The moving device advances and retracts the injection device 3 relative to the mold device. By advancing the injection device 3 toward the mold device, the injection device 3 is pressed against the fixed mold of the mold device. By retracting the injection device 3, the injection device 3 is separated from the fixed mold of the mold device.

The controller 4 repeatedly performs the measuring step, the mold closing step, the pressurizing step, the mold clamping step, the filling step, the pressure holding step, the cooling step, the depressurizing step, the mold opening step, the ejection step, and the like, thereby repeatedly manufacturing the molded product. A series of operations required to obtain a molded product, for example, from the start of a measuring step to the start of the next measuring step, is also called a molding cycle. The time required for one molding cycle is also referred to as a molding cycle time.

One molding cycle includes, for example, a measuring step, a mold closing step, a pressurizing step, a mold clamping step, a filling step, a holding pressure step, a cooling step, a depressurizing step, a mold opening step, and an ejection step in this order. The order here is the order of the start of each step. The filling step, the holding pressure step, and the cooling step are performed during the mold clamping step. The start of the mold clamping step may match the start of the filling step. The end of the depressurizing step match the start of the mold opening step.

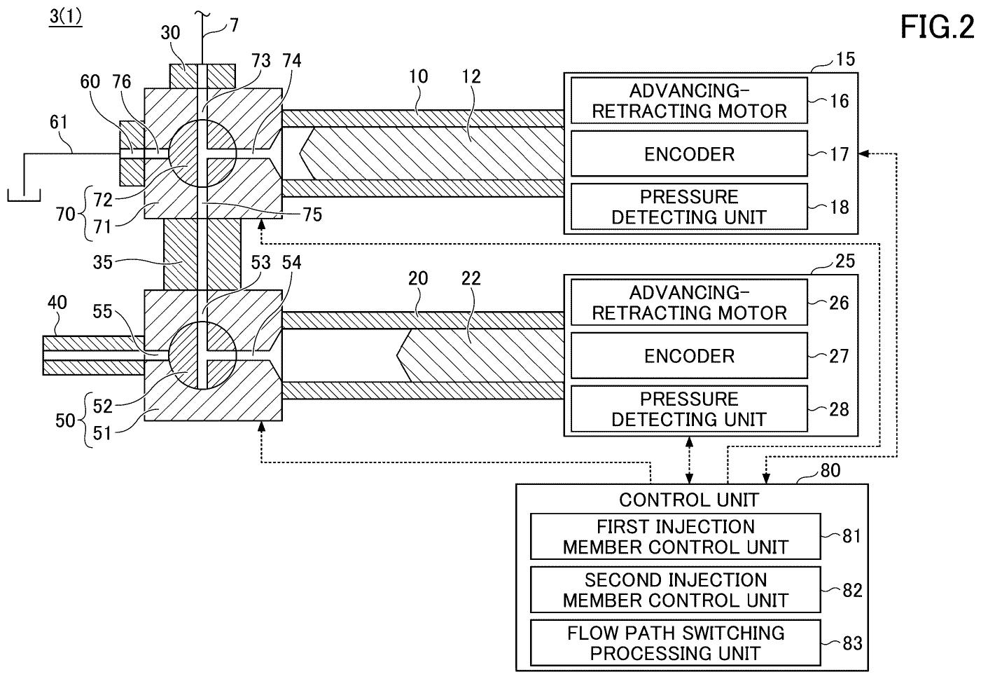

A plurality of steps may be performed simultaneously for the purpose of shortening the molding cycle time. For example, the measuring step may be performed during the cooling step of the previous molding cycle, or may be performed during the mold clamping step. In this case, the mold closing step may be performed at the beginning of the molding cycle. The filling step may be started during the mold closing step. The ejection step may be started during the mold opening step. In a case where the direction switching valve 50 (refer to FIG. 2) is provided in the injection device 3, the mold opening step may be started during the measuring step. This is because even if the mold opening step is started during the measuring step, the molding material does not leak from the nozzle 40 of the injection device 3 as long as the direction switching valve 50 closes the flow path of the injection device 3.

Further, one molding cycle may include a step other than the measuring step, the mold closing step, the pressurizing step, the mold clamping step, the filling step, the holding pressure step, the cooling step, the depressurizing step, the mold opening step, and the ejection step.

The molten resin supply device 6 supplies a molten resin (liquid molding material) which is a molten molding material to the injection device 3. Specifically, the molten resin supply device 6 melts a solid recycled resin (for example, a pelletized resin containing polyethylene terephthalate (PET)) while stirring the resin, and supplies the molten resin to the molten resin supply path 7 on the downstream side. The molten resin supply device 6 may be a pressure feeding device that continuously feeds the molten resin to the molten resin supply path 7 to apply a pressure feeding force to the fed molten resin to feed the molten resin under pressure.

The molten resin supply path 7 is a path for supplying the molten resin from the molten resin supply device 6 to the injection device 3. The molten resin supply path 7 may include, for example, a pipe through which the molten resin flows, a heat insulator that covers the pipe, and a heater that keeps the molten resin flowing through the pipe warm.

The control valve 8 is provided in the molten resin supply path 7, is connected to the controller 4 so as to be able to communicate, and switches between supply and supply stop of the molten resin to the injection device 3. As the control valve 8, for example, an on-off valve can be applied.

Although FIG. 1 illustrates a configuration in which one injection molding machine 1 is connected to the molten resin supply path 7, the injection molding machine system S is not limited to this configuration, and may have a configuration in which a plurality of injection molding machines 1 are connected to the molten resin supply path 7. Further, in FIG. 1, a configuration in which one molten resin supply device 6 is connected to the molten resin supply path 7 is illustrated, but the configuration of the present invention is not limited thereto, and the injection molding machine system S may have a configuration in which a plurality of molten resin supply devices 6 are connected to the molten resin supply path 7.

### <Configuration of Injection Device 3 According to Embodiment>

Next, the injection device 3 of the injection molding machine 1 will be described with reference to FIG. 2. FIG. 2 is a cross-sectional view schematically illustrating an injection device 3 of the injection molding machine 1 according to the embodiment.

The injection device 3 of the injection molding machine 1 injects a molten resin as a molding material into the mold device by using two cylinders. Specifically, the injection device 3 includes a reservoir cylinder (first cylinder) 10, a first injection member 12, an injection cylinder (second cylinder) 20, and a second injection member 22. The injection device 3 includes a first injection member driving unit 15 that operates the first injection member 12 and a second injection member driving unit 25 that operates the second injection member 22. Further, the injection device 3 includes a supply connector 30, a connection portion 35, a nozzle 40, a direction switching valve 50, a discharge portion 60, a discharge valve 70, and a control unit 80.

The reservoir cylinder 10 is formed in a cylindrical shape extending in the horizontal direction. The discharge valve 70 is connected to the distal end of the reservoir cylinder 10, and the first injection member driving unit 15 is provided at a base end of the reservoir cylinder 10. The molten resin is supplied from the distal end to the internal space of the reservoir cylinder 10 via the discharge valve 70. A heating device (not illustrated) that keeps the molten resin warm or heats the molten resin supplied to the internal space may be installed in a cylindrical wall forming the reservoir cylinder 10.

The first injection member 12 is formed as a solid rod member and is configured as a plunger provided so as to be able to advance and retract in the internal space of the reservoir cylinder 10. The axial center of the first injection member 12 is disposed coaxially with the axial center of the reservoir cylinder 10. The outer peripheral surface of the first injection member 12 is a smooth curved surface, and the outer diameter thereof is set to be the same as or slightly smaller than the inner diameter of the reservoir cylinder 10. Thus, the first injection member 12 can advance and retract (slide) relative to the reservoir cylinder 10. The first injection member 12 moves the molten resin supplied to the internal space of the reservoir cylinder 10 in accordance with the advancing and retracting of the first injection member 12.

The first injection-member driving unit 15 closes the base end of the reservoir cylinder 10 and holds the base end of the first injection member 12. For example, the first injection-member driving unit 15 includes an advancing-retracting motor 16, an encoder 17, and a pressure detecting unit 18.

The advancing-retracting motor 16 advances and retracts the first injection member 12 along the axial center of the reservoir cylinder 10. A motion conversion mechanism for converting the rotational motion of the advancing-retracting motor 16 into the linear motion of the first injection member 12 is provided between the first injection member 12 and the advancing-retracting motor 16. For example, a ball screw can be applied to the motion conversion mechanism.

The encoder 17 detects the rotation of the advancing-retracting motor 16 and transmits the detection signal to the control unit 80. The control unit 80 calculates the position and the moving speed of the first injection member 12 based on the detection signal of the encoder 17, and controls the operation of the first injection member 12 using the calculation results.

The pressure detecting unit 18 is provided in a transmission path between the advancing-retracting motor 16 and the first injection member 12, detects a force transmitted between the advancing-retracting motor 16 and the first injection member 12, and transmits a detection signal of the detected force to the control unit 80. The control unit 80 calculates the pressure of the first injection member 12 from the detected force, and adjusts or monitors the pressure received by the first injection member 12 from the molten resin (back pressure to the first injection member 12), the pressure acting on the molten resin from the first injection member 12, and the like.

Meanwhile, the injection cylinder 20 is formed in a cylindrical shape extending in parallel (horizontal direction) to the reservoir cylinder 10. The direction switching valve 50 is connected to the distal end of the injection cylinder 20, and the second injection member driving unit 25 is provided at a base end of the injection cylinder 20. The molten resin is supplied to the internal space of the injection cylinder 20 from the distal end side via the direction switching valve 50. A heating device (not illustrated) that keeps the molten resin warm or heats the molten resin supplied to the internal space may be installed in the cylinder wall forming the injection cylinder 20.

The second injection member 22 is formed as a solid rod member, and is provided so as to be able to advance and retract in the internal space of the injection cylinder 20, similarly to the first injection member 12. The axial center of the second injection member 22 is disposed coaxially with the axial center of the injection cylinder 20. The outer peripheral surface of the second injection member 22 is a smooth curved surface, and the outer diameter thereof is set to be the same as or slightly smaller than the inner diameter of the injection cylinder 20. Thus, the second injection member 22 can advance and retract (slide) relative to the injection cylinder 20. The second injection member 22 moves the molten resin supplied to the internal space of the injection cylinder 20 in accordance with the advancing and retracting of the second injection member 22.

The second injection member driving unit 25 closes the base end of the injection cylinder 20 and holds the base end of the second injection member 22. The second injection member driving unit 25 also includes an advancing-retracting motor 26, an encoder 27, and a pressure detecting unit 28, similarly to the first injection member driving unit 15.

The advancing-retracting motor 26 advances and retracts the second injection member 22 along the axial center of the injection cylinder 20. A motion conversion mechanism for converting the rotational motion of the advancing-retracting motor 26 into the linear motion of the second injection member 22 is provided between the second injection member 22 and the advancing-retracting motor 26. For example, a ball screw can be applied to the motion conversion mechanism.

The encoder 27 detects the rotation of the advancing-retracting motor 26 and transmits the detection signal to the control unit 80. The control unit 80 calculates the position and the moving speed of the second injection member 22 based on the detection signal of the encoder 27, and controls the operation of the second injection member 22 using the calculation results.

The pressure detecting unit 28 is provided in a transmission path between the advancing-retracting motor 26 and the second injection member 22, detects a force transmitted between the advancing-retracting motor 26 and the second injection member 22, and transmits a detection signal of the detected force to the control unit 80. The control unit 80 calculates the pressure of the second injection member 22 from the detected force, and adjusts or monitors the pressure received by the second injection member 22 from the molten resin (the back pressure to the second injection member 22), the pressure acting on the molten resin from the second injection member 22, and the like.

The supply connector 30 connects the molten resin supply path 7 (see FIG. 1) and the discharge valve 70. The supply connector 30 allows the molten resin supplied from the molten resin supply device 6 to flow into the discharge valve 70.

The connection portion 35 is a pipe provided between the direction switching valve 50 and the discharge valve 70, and allows the molten resin to flow through an internal flow path.

The nozzle 40 is installed at a position opposite to the injection cylinder 20 in the direction switching valve 50, and is formed in a cylindrical body communicating with a flow path (runner or the like) of the mold device. The nozzle 40 allows the molten resin extruded from the injection cylinder 20 to flow through the direction switching valve 50 and injects the molten resin into the mold device. The mold device molds a molded product by solidifying the molten resin filled in the cavity space from the nozzle 40.

The direction switching valve 50 is provided between the connection portion 35, the injection cylinder 20, and the nozzle 40, and switches the flow of the molten resin. The direction switching valve 50 includes a valve casing 51, a valve body 52, and a valve body driving unit (not illustrated).

The valve casing 51 is formed in a substantially rectangular parallelepiped shape and houses the valve body 52. The valve casing 51 has a supply side connection port 53 communicating with the flow path of the connection portion 35, an injection cylinder connection port 54 communicating with the internal space of the injection cylinder 20, and a nozzle connection port 55 communicating with the inside of the nozzle 40. The injection cylinder connection port 54 and the nozzle connection port 55 are provided, for example, on surfaces opposite to each other with the rotation center line of the valve body 52 interposed therebetween. The supply side connection port 53 is provided, for example, on a surface in a direction orthogonal to an axis line connecting the injection cylinder connection port 54 and the nozzle connection port 55.

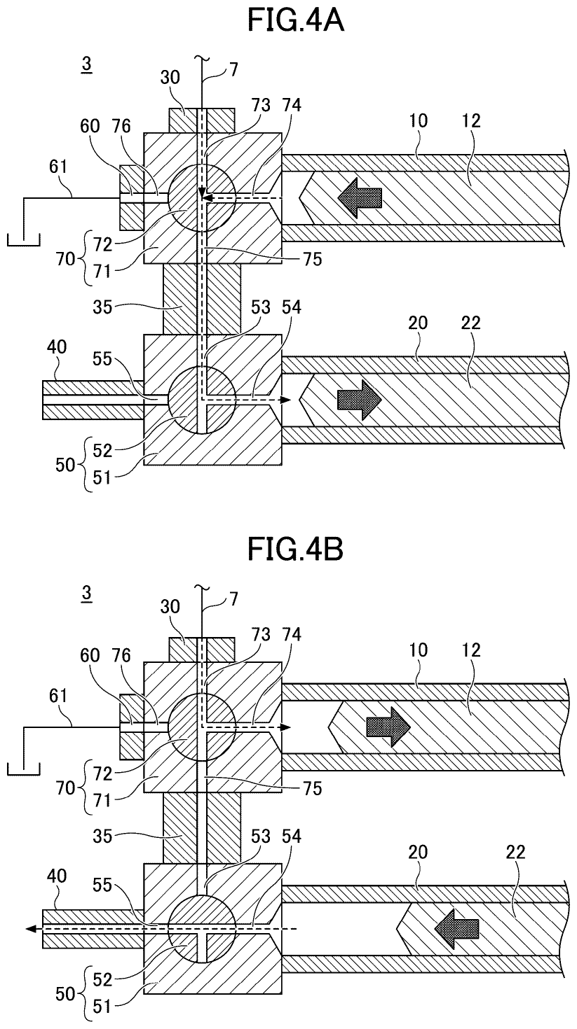

The valve body 52 switches the direction switching valve 50 between the first state and the second state by rotating inside the valve casing 51. In the first state, the valve body 52 allows the supply side connection port 53 and the injection cylinder connection port 54 to communicate with each other, and closes the nozzle connection port 55. In the second state, the valve body 52 allows the injection cylinder connection port 54 and the nozzle connection port 55 to communicate with each other, and closes the supply side connection port 53 (see also FIG. 4B). Thus, in the first state, the molten resin can be moved from the connection portion 35 toward the injection cylinder 20. In the second state, the molten resin can be moved from the injection cylinder 20 to the nozzle 40.

The valve body driving unit switches between the first state and the second state by rotating the valve body 52 in the valve casing 51. The state of the valve body 52 is not limited to the first state and the second state. For example, the valve body 52 can be in a state of simultaneously closing the supply side connection port 53, the injection cylinder connection port 54, and the nozzle connection port 55. The valve body 52 can be in a state of blocking the injection cylinder connection port 54 while communicating the supply side connection port 53 and the nozzle connection port 55.

The discharge portion 60 is a connector that is installed in the discharge valve 70 and is connected to a discharge path (not illustrated). The discharge portion 60 discharges the molten resin to the outside of the injection device 3 via a discharge path 61 based on the switching of the discharge valve 70.

The discharge valve 70 is provided between the molten resin supply path 7, the reservoir cylinder 10, the connection portion 35, and the discharge portion 60, and switches the flow of the molten resin. The discharge valve 70 includes a valve casing 71, a valve body 72, and a valve body driving unit (not illustrated).

The valve casing 71 is formed in a substantially rectangular parallelepiped shape and houses the valve body 72. The valve casing 71 includes a supply side connection port 73 communicating with the inside of the supply connector 30, a reservoir cylinder connection port 74 communicating with the internal space of the reservoir cylinder 10, a connection portion side connection port 75 communicating with the flow path of the connection portion 35, and a discharge side connection port 76 communicating with the inside of the discharge portion 60. For example, the reservoir cylinder connection port 74 and the discharge side connection port 76 are provided on opposite surfaces with the rotation center line of the valve body 72 interposed therebetween. The supply side connection port 73 and the connection portion side connection port 75 are provided on surfaces which are orthogonal to a virtual line connecting the reservoir cylinder connection port 74 and the discharge side connection port 76 and which are opposite to each other with the rotation center line of the valve body 72 interposed therebetween.

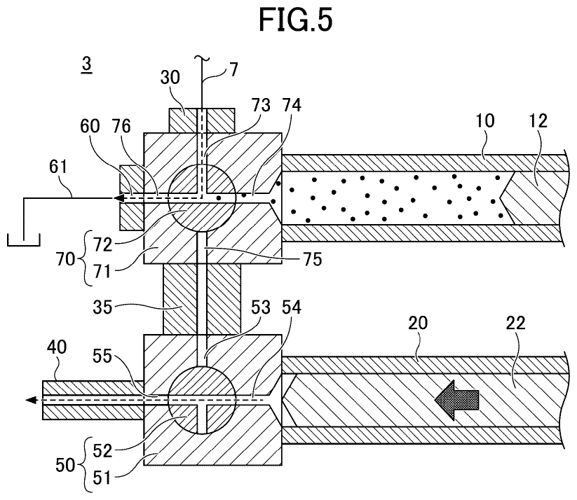

The valve body 72 rotates inside the valve casing 71 and is switched between the first state and the second state. In the first state, the valve body 72 allows the supply side connection port 73, the reservoir cylinder connection port 74, and the connection portion side connection port 75 to communicate with each other, and closes the discharge side connection port 76. In the second state, the valve body 72 allows the supply side connection port 73, the reservoir cylinder connection port 74, and the discharge side connection port 76 to communicate with each other, and closes the connection portion side connection port 75 (see also FIG. 5).

The valve body driving unit switches between the first state and the second state by rotating the valve body 72 in the valve casing 71. The state of the valve body 72 is not limited to the first state and the second state. For example, the valve body 72 can be in a state of closing the reservoir cylinder connection port 74 while allowing the supply side connection port 73, the connection portion side connection port 75, and the discharge side connection port 76 to communicate with each other. The valve body 72 can be in a state of closing the supply side connection port 73 while communicating the reservoir cylinder connection port 74, the connection portion side connection port 75, and the discharge side connection port 76.

The function of the control unit 80 may be implemented by any hardware, software, or a combination thereof. For example, the control unit 80 may be a computer including circuitry, or a processor, a memory, an input/output interface, and a communication interface, which are not illustrated. The processor is one or a combination of a central processing unit (CPU), a graphics processing unit (GPU), an application specific integrated circuit (ASIC), a field-programmable gate array (FPGA), a circuit including a plurality of discrete semiconductors, and the like, and executes a program stored in the memory. The memory includes a main storage device formed of a semiconductor memory or the like, and an auxiliary storage device formed of a disk, a semiconductor memory (flash memory), or the like.

The control unit 80 controls the operation of each component (the first injection member driving unit 15, the second injection member driving unit 25, the direction switching valve 50, the discharge valve 70, and the like) of the injection device 3 based on various instructions of the controller 4 that controls the entire injection molding machine system S. The injection molding machine system S may have a configuration in which the controller 4 also serves as the control unit 80 of the injection device 3 (that is, directly controls the injection device 3).

The control unit 80 constructs a first injection member control unit 81, a second injection member control unit 82, and a flow path switching processing unit 83 therein by the processor loading from the memory and executing the loaded program. The first injection member control unit 81 controls the operation of the first injection member 12. The second injection member control unit 82 controls the operation of the second injection member 22. The flow path switching processing unit 83 controls the states of the direction switching valve 50 and the discharge valve 70 to switch the flow direction of the molten resin.

### <Operation of Injection Device 3>

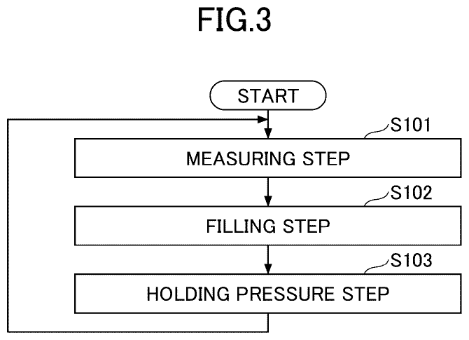

Next, the operation of the injection device 3 in the injection molding machine 1 will be described with reference to FIG. 3. FIG. 3 is a flowchart illustrating the operation of the injection device 3 in the injection molding machine 1. The injection device 3 sequentially performs a measuring step (step S101), a filling step (step S102), and a holding pressure step (step S103) illustrated in FIG. 3 under the control of the control unit 80, and repeats these steps.

In the measuring step, the injection device 3 accumulates a predetermined amount of molten resin on the distal end side (in a front side of the second injection member 22) of the internal space of the injection cylinder 20. In the filling step, the injection device 3 advances the second injection member 22 of the injection cylinder 20 to fill the cavity space of the mold device with the molten resin accumulated in the measuring step through the nozzle 40. In the holding pressure step, the injection device 3 extrudes the molten resin remaining in the injection cylinder 20 toward the mold device while maintaining the pressure (holding pressure) of the molten resin in the front side of the second injection member 22 at the set pressure. The injection molding machine 1 starts the cooling step after the holding pressure step to solidify the molten resin in the cavity space. For the purpose of shortening the molding cycle time, the injection molding machine 1 may perform the measuring step during the cooling step.

Next, specific operations in the respective steps will be described with reference to FIGS. 4A and 4B. FIG. 4A is a sectional view illustrating the operation of the injection device 3 in the measuring step. FIG. 4B is a view illustrating an operation of the injection device 3 in the injection step.

When the measuring step (step S101) is started, the flow path switching processing unit 83 of the control unit 80 controls the valve body driving unit of the direction switching valve 50 to bring the valve body 52 into the first state. That is, the flow path of the connection portion 35 and the internal space of the injection cylinder 20 are brought into a state of communicating with each other via the direction switching valve 50, and the molten resin can flow from the connection portion 35 to the injection cylinder 20. The flow path switching processing unit 83 of the control unit 80 controls the valve body driving unit of the discharge valve 70 to set the valve body 72 to the first state. That is, the internal space of the reservoir cylinder 10, the inside of the supply connector 30, and the flow path of the connection portion 35 are in a state of communicating with each other via the discharge valve 70, and the molten resin can flow from the reservoir cylinder 10 to the connection portion 35.

In the measuring step, the first injection member control unit 81 of the control unit 80 drives the advancing-retracting motor 16 to advance the first injection member 12. At this time, the first injection member control unit 81 calculates the position or the moving speed of the first injection member 12 based on the detection value of the encoder 17, and controls the moving speed of the first injection member 12. The first injection member 12 discharges the molten resin accumulated in the front side of the first injection member 12 in the internal space of the reservoir cylinder 10 from the distal end of the reservoir cylinder 10. The molten resin in the reservoir cylinder 10 moves to the connection portion 35 via the discharge valve 70. At this point, the molten resin is prevented from flowing backward in the molten resin supply path 7 on the supply connector 30 side of the discharge valve 70 by the closing of the control valve 8. Therefore, the molten resin in the reservoir cylinder 10 smoothly moves to the connection portion 35 side. The molten resin extruded from the reservoir cylinder 10 flows into the internal space from the distal end of the injection cylinder 20 via the connection portion 35 and the direction switching valve 50.

In addition, in the injection device 3 according to the embodiment, in the measuring step, the second injection member 22 is retracted by driving the advancing-retracting motor 26 by the second injection member control unit 82 of the control unit 80. That is, when the molten resin extruded from the reservoir cylinder 10 flows into the injection cylinder 20, the second injection member 22 is actively retracted in the injection cylinder 20 without depending on the molten resin. Thus, the pressure of the molten resin in the injection cylinder 20 can be greatly reduced as compared with the case where the molten resin supplied to the injection cylinder 20 presses the second injection member 22 to retract the second injection member 22.

Further, the second injection member control unit 82 of the control unit 80 calculates the position of the second injection member 22 based on the detection value of the encoder 27 in the retracting movement of the second injection member 22, and allows the second injection member 22 to retract while inhibiting the rapid retracting movement of the second injection member 22 by the advancing-retracting motor 26. This makes it possible to prevent an appropriate pressure from being applied to the molten resin supplied to the injection cylinder 20 and the internal space of the injection cylinder 20 from becoming a negative pressure. In addition, the injection device 3 may monitor the pressure of the molten resin by the pressure detecting unit 28 such as a load cell instead of the detection of the encoder 27 (or in combination with the detection of the encoder 27) and perform control so that the pressure does not excessively decrease. In this case, it is also possible to prevent the internal space of the injection cylinder 20 from becoming a negative pressure.

After the measuring step, the control unit 80 starts the filling step (step S102). As illustrated in FIG. 4B, the flow path switching processing unit 83 of the control unit 80 controls the valve body driving unit of the direction switching valve 50 to set the valve body 52 to the second state. That is, the internal space of the injection cylinder 20 and the flow path of the nozzle 40 are communicated with each other via the direction switching valve 50, and the flow path of the connection portion 35 is blocked.

In the filling step, the second injection member control unit 82 of the control unit 80 drives the advancing-retracting motor 26 to advance the second injection member 22 to a predetermined position. At this time, the second injection member control unit 82 calculates the position or the moving speed of the second injection member 22 based on the detection value of the encoder 27, and controls the moving speed of the second injection member 22. The second injection member 22 discharges the molten resin accumulated in the front side of the second injection member 22 in the internal space of the injection cylinder 20 from the distal end of the injection cylinder 20. The molten resin in the injection cylinder 20 moves to the nozzle 40 via the direction switching valve 50, flows through the flow path of the nozzle 40, and is filled in the cavity space of the mold device.

In addition, the injection device 3 according to the embodiment performs a process (reservoir storing step) of supplying the molten resin to the internal space of the reservoir cylinder 10 in the filling step in which the injection cylinder 20 injects the molten resin into the mold device. Therefore, the flow path switching processing unit 83 of the control unit 80 maintains the first state of the valve body 72 of the discharge valve 70. Thus, in the reservoir storing step, the molten resin pressure-fed from the molten resin supply device 6 through the molten resin supply path 7 flows into the internal space from the distal end of the reservoir cylinder 10 via the supply connector 30 and the discharge valve 70. In the direction switching valve 50, since the connection portion 35 is closed by the valve body 52, the molten resin supplied from the molten resin supply device 6 under the opening of the control valve 8 smoothly flows into the reservoir cylinder 10 without flowing toward the connection portion 35.

The first injection member 12 of the reservoir cylinder 10 is pushed by the supplied molten resin, and thus retracts relative to the reservoir cylinder 10. Alternatively, the first injection member control unit 81 of the control unit 80 may control the advancing-retracting motor 16 based on the pressure feeding force of the molten resin pressure-fed from the molten resin supply device 6 to retract the first injection member 12 in the reservoir storing step. For example, the first injection member control unit 81 may adjust the retracting speed of the first injection member 12 so that the pressure of the molten resin detected by the pressure detecting unit 18 matches the target pressure.

After the filling step described above, the control unit 80 starts a holding pressure step (step S103). In this case, the second injection member control unit 82 of the control unit 80 controls the rotation of the advancing-retracting motor 26 based on the detection value of the pressure detecting unit 28 so as to maintain the pressure (holding pressure) of the molten resin extruded by the second injection member 22 at the set pressure, and advances the second injection member 22. By the advancing movement of the second injection member 22, the second injection member 22 can extrude the molten resin remaining in the internal space of the injection cylinder 20 toward the mold device. In addition, in the holding pressure step, the control unit 80 may continue the reservoir storing step described above.

As described above, the injection molding machine 1 can repeatedly manufacture molded products by interlocking the mold clamping device 2, the ejector unit, and the moving unit while performing the measuring step, the filling step, and the holding pressure step in the injection device 3. The control unit 80 of the injection device 3 determines whether or not the reservoir cylinder 10 can receive the molten resin, and can perform control of discharging the molten resin when the molten resin cannot be received. FIG. 5 is a sectional view illustrating an operation of discharging a molten resin in an injection device 3.

When the molten resin is discharged, the flow path switching processing unit 83 of the control unit 80 controls the valve body driving unit of the discharge valve 70 to set the valve body 72 to the second state. That is, the internal space of the reservoir cylinder 10, the inside of the supply connector 30, and the inside of the discharge portion 60 are in communication with each other via the discharge valve 70, and the molten resin can be discharged via the discharge portion 60. For example, in a state where a set volume of molten resin is supplied to the internal space of the reservoir cylinder 10 in the reservoir storing step, the molten resin supplied from the molten resin supply device 6 is not directed to the reservoir cylinder 10. Therefore, the molten resin is discharged from the discharge portion 60 and the discharge path 61 to the outside of the injection device 3. This makes it possible to prevent the occurrence of clogging or the like of the molten resin in the reservoir cylinder 10 and the discharge valve 70.

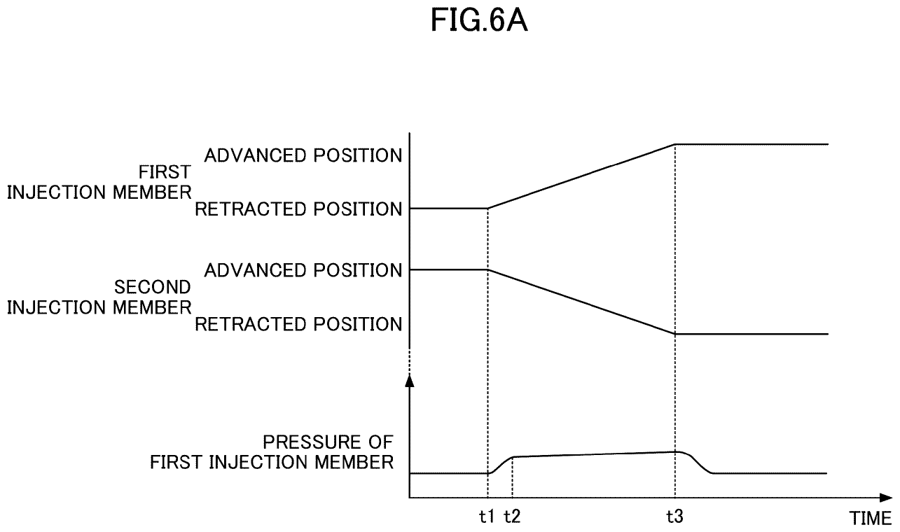

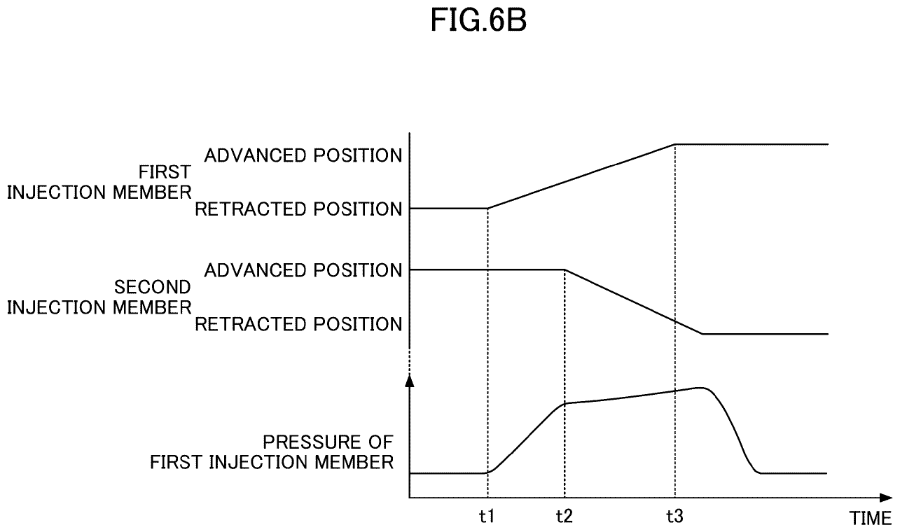

Next, the significance of the operation of retracting the second injection member 22 in the measuring step for supplying the molten resin to the injection cylinder 20 will be described with reference to FIGS. 6A and 6B. FIG. 6A is a timing chart illustrating an operation of each injection member in the measuring step of the injection device 3 according to the embodiment. FIG. 6B is a timing chart illustrating an operation of each plunger in a measuring step of the injection device according to a reference example.

First, an injection device according to a reference example will be described. As illustrated in FIG. 63, the injection device according to the reference example advances the first plunger from the retracted position toward the advanced position (discharge valve) at a time point t1 at which the measuring step is started. As a result, the molten resin in the reservoir cylinder is extruded by the first plunger and supplied to the injection cylinder communicating with the reservoir cylinder. The second plunger, which has been located at the advanced position in the internal space of the injection cylinder, receives the pressure of the molten resin supplied from the reservoir cylinder. The second plunger start to retract from the advanced position at a time point t2 at which the pressure of the molten resin reaches a predetermined pressure or more.

That is, the second plunger retracts in the internal space of the injection cylinder by receiving the pressure of the molten resin extruded by the first plunger. Therefore, the pressure applied to the first plunger by the advancing-retracting motor of the first plunger increases rapidly from the time point t1 to the time point t2, and then decreases gradually from the time point t2 at which the second plunger retracts. However, at the time point t2, the pressure of the first plunger extrudes the molten resin at a very high pressure value (e.g., 30 MPa to 40 MPa). This is because, in addition to the force to extrude the molten resin, a force to retract the second plunger is required.

The large pressure applied to the first plunger continues up to a time point t3, at which the second plunger reaches the retracted position, during which the first plunger continues to receive the large pressure. As a result, the first plunger is subjected to a large pressure over a long period of the measuring step. Therefore, the injection device according to the reference example is likely to have disadvantages such as damage to the first plunger and a large amount of energy required for driving the first plunger.

By contrast, as illustrated in FIG. 6A, in the injection molding machine 1 according to the embodiment, similarly to the injection molding machine according to the reference example, the first injection member 12 is advanced from the retracted position to the advanced position at the time point t1 at which the measuring step is started. As a result, the molten resin in the reservoir cylinder 10 is extruded by the first injection member 12 and supplied to the injection cylinder 20 communicating with the reservoir cylinder 10.

However, the injection molding machine 1 operates the advancing-retracting motor 26 to retract the second injection member 22 from the advanced position toward the retracted position at the time point t1 (at the same time as the start of the advancing of the first injection member 12). In other words, before the second injection member 22 starts retracting by the pressure of the molten resin supplied from the reservoir cylinder 10, the second injection member 22 retracts in accordance with the advancing of the first injection member 12. Thus, the injection molding machine 1 can prevent an increase in the pressure of the molten resin due to the second injection member 22 being stopped until the second injection member starts retracting by the pressure of the molten resin with respect to the molten resin supplied to the injection cylinder 20. For example, the pressure of the molten resin material from the injection cylinder 20 to the reservoir cylinder 10 applies to the first injection member 12 slightly increases until the time point t2, but the magnitude of the increase is about 10 MPa. In this measuring step, this pressurization (about 10 MPa) continues until the time point t3, and the load applied to the first injection member 12 is reduced in the entire measuring step. The injection molding machine 1 may start retracting the second injection member 22 after the pressure of the molten resin in the injection cylinder 20 is slightly increased with the advancing of the first injection member 12.

As a result, the injection molding machine 1 can prevent damage, and the like, and prevent durability of the first injection member 12 and the reservoir cylinder 10 being reduced. Further, the injection molding machine 1 can promote weight reduction and cost reduction of the first injection member 12 itself or its related parts by reducing the force of the first injection member 12. In particular, when recycled resin is applied as molten resin, a device for supplying molten resin from the distal end of the reservoir cylinder 10 to the internal space and extruding the molten resin from the distal end is used in order to prevent deterioration of the molten resin. When the molten resin is supplied from the distal end of the reservoir cylinder 10 and the molten resin is extruded from the distal end, a part of a path for supplying the molten resin and a part of a path for extruding the molten resin overlap each other inside the discharge valve 70. The pressure in the path for supplying the molten resin (the molten resin supply path 7 and the supply side connection port 73) is high due to the presence of the molten resin to be supplied, and most of the molten resin flows toward the path for extruding the molten resin (the connection portion 35 and the connection portion side connection port 75). However, when the pressure on the downstream side of the path for extruding the molten resin is high, the molten resin in the reservoir cylinder 10 may flow back to the molten resin supply path 7. However, as described above, the pressure of the molten resin on the downstream side is lowered by retracting the injection cylinder 20, and thus the molten resin easily flows into the injection cylinder 20 rather than flowing back to the molten resin supply path 7. Therefore, the injection molding machine 1 can control the flow of the molten resin without installing the discharge valve 70, for example.

In the measuring step, the control unit 80 starts retracting the second injection member 22 in accordance with starting the advancement of the first injection member 12. Depending on the pressure of the resin existing in the path for supplying the molten resin from the distal end of the reservoir cylinder 10 to the internal space of the injection cylinder 20, the second injection member 22 may start retracting before the first injection member 12 advances. In this case, it is necessary to devise a structure and control in order to prevent a decrease in temperature of the molten resin and prevent air bubbles from mixing into the molten resin due to a decrease in the pressure. Since it becomes easy to steadily maintain the pressure of the molten resin at a positive pressure, the injection molding machine 1 is preferably controlled (or set) to start retracting the second injection member 22 as of the first injection member 12 starting to advance. Alternatively, in a case where the second injection member 22 retracts before the first injection member 12 advances, the injection molding machine 1 may monitor the pressure of the molten resin by detection of the pressure detecting unit 28 such as a load cell and control the pressure so as not to be excessively lowered. Thus, the second injection member 22 can be smoothly retracted while appropriately maintaining the pressure (positive pressure) in the internal space of the injection cylinder 20.

In addition, in the measuring step, the control unit 80 preferably sets a retracting speed of the second injection member 22 to be equal to or lower than an advancing speed of the first injection member 12. That is, the control unit 80 retracts the second injection member 22 so as to match the theoretical supply amount of the molten resin supplied to the injection cylinder 20. For example, the control unit 80 performs control to make the advancing speed of the first injection member 12 and the retracting speed of the second injection member 22 the same speed. This enables the pressure of the molten resin flowing into the inner space of the injection cylinder 20 to be maintained at a positive pressure while preventing a large increase in the pressure of the molten resin. Further, for example, the control unit 80 can reliably prevent the second injection member 22 from retracting earlier than the molten resin flows in by setting the retracting speed of the second injection member 22 to a speed slightly slower than the advancing speed of the first injection member 12. In this case, since the interval between the first injection member 12 and the second injection member 22 may be relatively narrowed, the speed of the second injection member 22 may temporarily exceed the speed of the first injection member 12. Therefore, the average speed of the second injection member 22, the integral value after the second injection member 22 starts moving, or the like is preferably controlled to be greater than the average speed, the integral value of the first injection member 12, or the like. The control unit 80 may control the speed of the first injection member 12 and the second injection member 22 using information relating to the relative positional relationship such as the mutual speeds, accelerations, or positions of the first injection member 12 and the second injection member 22.

Alternatively, the control unit 80 may control the retracting speed of the second injection member 22 while monitoring the pressure of the first injection member 12 by the pressure detecting unit 18. In this case, it is also possible to reduce the pressure with which the first injection member 12 presses the molten resin. Further, the control unit 80 may control the retracting speed of the second injection member 22 while monitoring the pressure of the second injection member 22 by the pressure detecting unit 28. Thus, the pressure of the injection cylinder 20 can be controlled so as not to be excessively lowered, and the negative pressure of the injection cylinder 20 can be prevented.

Further, the control unit 80 stops retracting the second injection member 22 in accordance with the first injection member 12 stopping advancing in the measuring step. For example, the control unit 80 performs control such that the second injection member 22 stops retracting simultaneously with a timing at which the first injection member 12 stops advancing, or at a timing slightly later than the timing at which the first injection member 12 stops advancing. This makes it possible to easily avoid the internal space of the injection cylinder 20 from becoming a negative pressure.

The timing at which the second injection member 22 retracts may be slightly later than the time point t1, instead of being simultaneous with timing at which the first injection member 12 stops advancing. In other words, the second injection member 22 starts retracting as of the first injection member 12 starting to advance. For example, the control unit 80 may perform control to start retracting the second injection member 22 after a predetermined period has elapsed from the time point t1 at which the first injection member 12 starts advancing. Alternatively, the control unit 80 may monitor the pressure applied to the second injection member 22 by the pressure detecting unit 28 and retract the second injection member 22 at the timing at which the pressure of the second injection member 22 starts to increase. Thus, the injection device 3 can more stably prevent the internal pressure of the injection cylinder 20 from becoming negative pressure, and can prevent a decrease in the temperature of the molten resin and can prevent the mixing of air bubbles caused by the negative pressure.

### <Configuration and Operation of Injection Device 3A According to Another Embodiment>

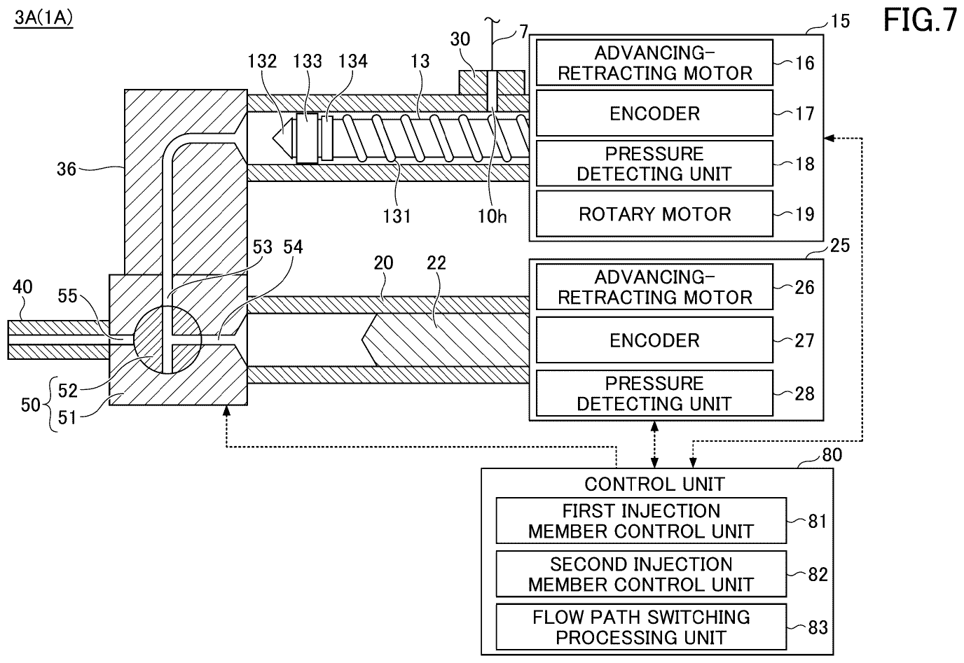

FIG. 7 is a sectional view schematically illustrating an injection device 3A of an injection molding machine 1A according to another embodiment. The injection molding machine 1A according to another embodiment is different from the injection molding machine 1 according to the embodiment in that a screw is used as a first injection member 13 and the molten resin is supplied to the internal space of the reservoir cylinder 10 from a rearward position relative to the distal end of the first injection member 13. The configurations of the injection cylinder 20, the nozzle 40, and the direction switching valve 50 of the injection device 3A are identical to those of the injection device 3 according to the embodiment, and therefore, detailed description thereof is omitted.

The reservoir cylinder 10 has a hole 10h at its base end for introducing the molten resin into the inner space. A supply connector 30 connected to the molten resin supply path 7 is provided on the hole 10h. Further, a heating device (not illustrated) for keeping the temperature of or heating the molten resin supplied to the internal space may be installed in the cylindrical wall forming the reservoir cylinder 10.

The first injection member 13 is configured to be rotatable around the axis in the reservoir cylinder 10 by a rotary motor 19 provided in the first injection member driving unit 15. A spiral flight 131 is formed to protrude on the outer peripheral surface of the first injection member 13. A screw head 132, a backflow prevention ring 133, a sealing ring 134, and the like are provided at the distal end of the first injection member 13. The first injection member 13 is rotated around the axis in the reservoir cylinder 10, and thereby, the first injection member 13 can move the molten resin supplied from the hole 10h forward while kneading the molten resin, and can supply the molten resin to the internal space at the front side of the screw head 132.

Further, instead of the discharge valve 70, a connection portion 36 that connects the reservoir cylinder 10 and the direction switching valve 50 without switching the flow path is provided at the distal end of the reservoir cylinder 10. The connection portion 36 has a flow path therein that communicates with the supply side connection port 53 of the direction switching valve 50. Thus, the injection device 3 can supply the molten resin to the injection cylinder 20 via the connection portion 36 and the direction switching valve 50.

In the reservoir storing step, the control unit 80 can store the molten resin on the distal end side of the reservoir cylinder 10 by blocking the supply side connection port 53 by the valve body 52 of the direction switching valve 50. In the measuring step of the injection cylinder 20, the control unit 80 controls the advancing-retracting motor 16 to advance the first injection member 13, thereby discharging the molten resin from the reservoir cylinder 10. At this time, as in the embodiment, the control unit 80 controls the advancing-retracting motor 26 to retract the second injection member 22 of the injection cylinder 20 in accordance with the advancement of the first injection member 13, and thus the molten resin can be smoothly supplied while reducing the pressure applied to the first injection member 13.

In addition, in the injection step (filling step, holding pressure step) after the measuring step, the control unit 80 discharges the molten resin from the distal end of the injection cylinder 20 by advancing of the second injection member 22, and fills the molten resin in the cavity space of the mold device.

Therefore, the injection molding machine 1A according to another embodiment can also reduce the pressure applied to the first injection member 13 at the time of extruding the molten resin. As a result, the injection molding machine 1A can improve the durability of the first injection member 13 and the reservoir cylinder 10, and can reduce the energy required for the first injection member 13 to extrude the molten resin.

The injection device 3A according to the another embodiment may be configured to supply a solid (for example, pelletized) molding material as the molding material to be supplied to the reservoir cylinder 10 and heat the reservoir cylinder 10. The injection molding machine 1A may be configured to transfer the molten resin from the molten-plastic supplying device 6 to the injection device 3 by the pressure. In this case, the first injection member 13 may be configured not to include the flight.

As described above, the injection molding machine 1A according to another embodiment, which includes the first injection member 13 acting as a screw, in the reservoir cylinder 10, can also perform the same control as the injection molding machine 1 according to the embodiment. In particular, the injection device 3A is configured to supply the molten resin from the base end of the reservoir cylinder 10 to the internal space and extrude the molten resin from the distal end of the reservoir cylinder 10. Thus, the injection device 3A can smoothly extrude the molten resin from the distal end of the reservoir cylinder 10 to the injection cylinder 20 based on the advancing of the first injection member 13, without the configuration of the discharge valve 70 or the like for switching the flow path.

In the measuring step, the control unit 80 can prevent the increase in the pressure of the molten resin due to the stop of the second injection member 22 by retracting the second injection member 22 in accordance with advancing of the first injection member 13, independent of the pressure of the molten resin supplied from the reservoir cylinder 10. As a result, the injection molding machine 1A can prevent the occurrence of damage or the like in the first injection member 13 and the reservoir cylinder 10 and the deterioration of durability. Further, the injection molding machine 1A can promote the weight reduction and cost reduction of the first injection member 13 itself or the associated parts (the screw head 132, the backflow prevention ring 133, and the sealing ring 134) by reducing the power of the first injection member 13.

In addition, in the injection device 3A, it is preferable to control (or set) the second injection member 22 to start retracting as of the first injection member 13 starting to advance. However, even in injection device 3A, the second injection member 22 may start retracting before the first injection member 13 advances, depending on the pressure of the resin present in the path that supplies molten resin from the distal end of the reservoir cylinder 10 to the internal space of injection cylinder 20.

The control unit 80 may control the movements of the first injection member 13 and the second injection member 22 so as to match the theoretical supply amount of the molten resin supplied to the injection cylinder 20. For example, the control unit 80 performs control to set an advancing speed of the first injection member 13 and a retracting speed of the second injection member 22 at the same speed. This enables the pressure of the molten resin flowing into the inner space of the injection cylinder 20 to be maintained at a positive pressure while preventing a large increase in the pressure of the molten resin. Further, the control unit 80 can reliably prevent the second injection member 22 from retracting earlier than the molten resin flows in by setting the retracting speed of the second injection member 22 to a speed slightly slower than the advancing speed of the first injection member 13. Further, the average speed of the second injection member 22, the integral value after the second injection member 22 starts moving, or the like is preferably controlled so that the average speed, the integral value of the first injection member 13, or the like is larger. The control unit 80 may control the speeds of the first injection member 13 and the second injection member 22 using information on a relative positional relationship such as the mutual speeds, acceleration, or positions of the first injection member 13 and the second injection member 22. Alternatively, the control unit 80 may control the retracting speed of the second injection member 22 while monitoring the pressure of the second injection member 22 by the pressure detecting unit 28. Thus, the pressure of the injection cylinder 20 can be controlled so as not to be excessively lowered, and the negative pressure of the injection cylinder 20 can be prevented.

The injection molding machines 1 and 1A illustrated herein are for illustrative purposes only and are not intended to be restrictive in any way. The embodiments can be modified and improved in various aspects without departing from the scope and spirit of the appended claims. The matters described in the plurality of embodiments can be combined with each other within a range not inconsistent with each other. The matters described in the above embodiments may be configured in other ways without any contradiction, and may be combined without any contradiction.

Although embodiments of the present disclosure have been described above in detail, the present disclosure is not limited to such specific embodiments, and various alterations and modifications are possible within the scope of the claims as recited.

What is claimed is:

1. An injection molding machine comprising:
a first cylinder to which a molding material is supplied;
a first injection member provided in the first cylinder, the first injection member being configured to advance and retract;
a second cylinder to which the molding material extruded from the first cylinder is supplied;
a second injection member provided in the second cylinder, the second injection member being configured to advance and retract; and
circuitry configured to control operations of the first injection member and the second injection member,
wherein the circuitry controls a measuring step for supplying the molding material to the second cylinder by advancing the first injection member, and
wherein the circuitry retracts the second injection member in accordance with the advancing of the first injection member in the measuring step.

2. The injection molding machine according to claim 1, wherein the circuitry starts retracting the second injection member as of the first injection member starting to advance in the measuring step.

3. The injection molding machine according to claim 1, wherein the circuitry stops retracting the second injection member in accordance with the first injection member stopping advancing in the measuring step.

4. The injection molding machine according to claim 1, wherein the circuitry sets a retracting speed of the second injection member to be equal to or lower than an advancing speed of the first injection member in the measuring step.

5. The injection molding machine according to claim 1,
wherein the first cylinder supplies the molding material to an internal space of the first cylinder from a front side of the first cylinder to accumulate the molding material in the front side of the first injection member, and discharges the molding material from the front side of the first cylinder by advancing the first injection member, and
wherein the second cylinder supplies the molding material to an internal space of the second cylinder from a front side of the second cylinder to accumulate the molding material in the front side of the second injection member, and discharges the molding material from the front side of the second cylinder by advancing the second injection member.

6. The injection molding machine according to claim 5, wherein the first injection member is a plunger that slides relative to the first cylinder and extrudes the molding material accumulated in the front side of the first injection member.

7. The injection molding machine according to claim 1,
wherein the first cylinder supplies the molding material to an internal space of the first cylinder from a rearward position relative to a distal end of the first injection member to accumulate the molding material in a front side of the first injection member, and discharges the molding material from a front side of the first cylinder by advancing the first injection member, and
wherein the second cylinder supplies the molding material to an internal space of the second cylinder from a front side of the second cylinder to accumulate the molding material in the front side of the second injection member, and discharges the molding material from the front side of the second cylinder by advancing the second injection member.

8. The injection molding machine according to claim 7, wherein the first injection member is a screw having a spiral flight on an outer peripheral surface, the first injection member being configured to rotate in the internal space of the first cylinder, and accumulate the molding material in the front side of the first injection member by the rotation.
